(19) United States
(12) Patent Application Publication
(10) Pub. No.: US 2024/0296487 A1
(43) Pub. Date: Sep. 5, 2024

(54) VIRTUAL ITEM TRANSACTION METHOD AND APPARATUS BASED ON PARTICIPATION OF TRANSACTION ENTITIES

(71) Applicant: Yun-Ju LEE, Seoul (KR)

(72) Inventor: Yun-Ju Lee, Seoul (KR)

(21) Appl. No.: 18/426,923

(22) Filed: Jan. 30, 2024

(30) Foreign Application Priority Data
Mar. 3, 2023 (KR) 10-2023-0028635

(51) Int. Cl. G06Q 30/0601; G06Q 30/08

(52) U.S. Cl. CPC G06Q 30/0601; G06Q 30/08

(57) ABSTRACT

Disclosed herein are a virtual item transaction method and apparatus based on participation of transaction entities. The virtual item transaction method is performed by a virtual item transaction agent to allow a physical item rights holder, a virtual item creator, and a virtual platform service provider to participate in a virtual item transaction, and includes receiving a virtual item creation request of the physical item rights holder, conducting bidding for virtual item source data corresponding to the virtual item creation request, and receiving an issuance request for a virtual item present in a virtual item issuance list from the virtual platform service provider.

### CROSS REFERENCE TO RELATED APPLICATION

This application claims the benefit of Korean Patent Application No. 10-2023-0028635, filed Mar. 3, 2023, which is hereby incorporated by reference in its entirety into this application.

### BACKGROUND OF THE INVENTION

### 1. Technical Field

The present disclosure relates generally to technology for supporting virtual item transactions (or trading) based on the participation of transaction entities.

More particularly, the present disclosure relates to technology for promoting the participation of each transaction entity and distributing profit when implementing physical items, existing in the real world, in virtual reality.

### 2. Description of the Related Art

Virtual reality (VR) refers to a specific environment or situation which is generated through artificial technology using a computer or the like and which is similar to, but is not actual, reality, or refers to the technology itself. Recently, with the acceleration of technological advancements such as computing and image processing, an interest in virtual reality and metaverse is increasing.

Roblox, which holds a largest number of users among global metaverse platforms, currently has over 200 million monthly active users in about 180 countries, and the number of users continues to be on an increasing trend.

As the market scale of metaverse platforms increases in this way, a demand for items issued in the metaverse or virtual reality is also increasing. In the case of virtual items, items may be issued in new designs that are not present before, but it is also possible to issue items using intellectual property (e.g., design rights, copyrights, etc.) present in the real world. Jepeto, a representative metaverse platform, has collaborated with the luxury brand Gucci to release virtual items, and such attempts are expected to gradually increase.

Therefore, there is the need for a transaction support method that encourages entities who hold rights to physical items in the real world, item creators, and platform service providers to easily participate in the creation of virtual items and that distributes profit created from these items.

### SUMMARY OF THE INVENTION

Accordingly, the present disclosure has been made keeping in mind the above problems occurring in the prior art, and an object of the present disclosure is to provide a transaction environment in which a physical item rights holder, a virtual item creator, and a virtual platform service provider are capable of participating in the issuance of a virtual item.

Another object of the present disclosure is to efficiently distribute profit generated from the issuance of a virtual item.

A further object of the present disclosure is to efficiently manage virtual item source data, an issuance list, etc. using databases.

In accordance with an aspect of the present disclosure to accomplish the above objects, there is provided a virtual item transaction method based on participation of transaction entities, the virtual item transaction method being performed by a virtual item transaction agent to allow a physical item rights holder, a virtual item creator, and a virtual platform service provider to participate in a virtual item transaction, the virtual item transaction method including receiving a virtual item creation request of the physical item rights holder; conducting bidding for virtual item source data corresponding to the virtual item creation request; and receiving an issuance request for a virtual item present in a virtual item issuance list from the virtual platform service provider.

The virtual item creation request of the physical item rights holder may correspond to a response to a virtual item creation request of the virtual item creator or the virtual platform service provider.

The virtual item creation request may include information about a virtual item creation program, a size of virtual item source data, a virtual item creation deadline, a virtual item issuance price, and a virtual item shape.

The virtual item creation request may include information about a profit distribution rate of the physical item rights holder, the virtual item creator, and the virtual platform service provider, for profit generated from issuance of a corresponding virtual item.

The virtual item transaction method may further include, after the virtual item source data is received, distributing profit, generated from a virtual item issued based on the virtual item source data, depending on the profit distribution rate.

Conducting bidding for the virtual item source data may include receiving virtual item source data from the virtual item creator; storing the received virtual item source data in a virtual item source data bid list; receiving information about virtual item source data selected by the physical item rights holder; and deleting source data, other than the selected virtual item source data, from the virtual item source data bid list.

Conducting bidding for the virtual item source data may further include storing source data, other than the selected virtual item source data in the virtual item source data bid list, in a virtual item source data bidding failure list, and the virtual item transaction method may further include receiving an issuance request for virtual item source data present in the virtual item source data biding failure list from the physical item rights holder or the virtual platform service provider.

The virtual item issuance list may include virtual item source data received from the physical item rights holder, and the virtual item transaction method may further include, when the virtual item source data is received from the physical item rights holder, receiving information about a profit distribution rate of the physical item rights holder and the virtual platform service provider.

In accordance with another aspect of the present disclosure to accomplish the above objects, there is provided a virtual item transaction apparatus based on participation of transaction entities for performing a virtual item transaction in which a physical item rights holder, a virtual item creator, and a virtual platform service provider participate, the virtual item transaction apparatus including a communication unit configured to receive a virtual item creation request of a physical item rights holder and receive an issuance request for a virtual item present in a virtual item issuance list from the virtual platform service provider; and a bidding unit configured to conduct bidding for virtual item source data corresponding to the virtual item creation request.

The virtual item creation request of the physical item rights holder may correspond to a response to a virtual item creation request of the virtual item creator or the virtual platform service provider.

The virtual item creation request may include information about a virtual item creation program, a size of virtual item source data, a virtual item creation deadline, a virtual item issuance price, and a virtual item shape.

The virtual item creation request may include information about a profit distribution rate of the physical item rights holder, the virtual item creator, and the virtual platform service provider, for profit generated from issuance of a corresponding virtual item.

The virtual item transaction apparatus may further include a profit distribution unit configured to distribute profit, generated from a virtual item issued based on the virtual item source data after the virtual item source data is received, depending on the profit distribution rate.

The bidding unit may be configured to store virtual item source data received from the virtual item creator in a virtual item source data bid list and delete source data, other than virtual item source data selected by the physical item rights holder.

The bidding unit may be configured to store source data, other than the selected virtual item source data in the virtual item source data bid list, in a virtual item source data bidding failure list, and the communication unit may be configured to receive an issuance request for virtual item source data present in the virtual item source data biding failure list from the physical item rights holder or the virtual platform service provider.

The virtual item issuance list may include virtual item source data received from the physical item rights holder, and the communication unit may receive information about a profit distribution rate of the physical item rights holder and the virtual platform service provider, when the virtual item source data is received from the physical item rights holder.

### BRIEF DESCRIPTION OF THE DRAWINGS

The above and other objects, features and advantages of the present disclosure will be more clearly understood from the following detailed description taken in conjunction with the accompanying drawings, in which:

FIG. 1 is a flowchart illustrating a virtual item transaction method based on the participation of transaction entities according to an embodiment of the present disclosure;

FIG. 2 is a block diagram illustrating a virtual item transaction system according to an embodiment of the present disclosure;

FIG. 3 is a flowchart illustrating a virtual item transaction method for each entity according to an embodiment of the present disclosure;

FIG. 4 is a block diagram illustrating a virtual item transaction apparatus based on the participation of transaction entities according to an embodiment of the present disclosure;

FIG. 5 is a block diagram illustrating in detail a data storage unit according to an embodiment; and

FIG. 6 is a diagram illustrating the configuration of a computer system according to an embodiment.

### DESCRIPTION OF THE PREFERRED EMBODIMENTS

Advantages and features of the present disclosure and methods for achieving the same will be clarified with reference to embodiments described later in detail together with the accompanying drawings. However, the present disclosure is capable of being implemented in various forms, and is not limited to the embodiments described later, and these embodiments are provided so that this disclosure will be thorough and complete and will fully convey the scope of the present disclosure to those skilled in the art. The present disclosure should be defined by the scope of the accompanying claims. The same reference numerals are used to designate the same components throughout the specification.

It will be understood that, although the terms “first” and “second” may be used herein to describe various components, these components are not limited by these terms. These terms are only used to distinguish one component from another component. Therefore, it will be apparent that a first component, which will be described below, may alternatively be a second component without departing from the technical spirit of the present disclosure.

The terms used in the present specification are merely used to describe embodiments, and are not intended to limit the present disclosure. In the present specification, a singular expression includes the plural sense unless a description to the contrary is specifically made in context. It should be understood that the term “comprises” or “comprising” used in the specification implies that a described component or step is not intended to exclude the possibility that one or more other components or steps will be present or added.

In the present specification, each of phrases such as “A or B”, “at least one of A and B”, “at least one of A or B”, “A, B, or C”, “at least one of A, B, and C”, and “at least one of A, B, or C” may include any one of the items enumerated together in the corresponding phrase, among the phrases, or all possible combinations thereof.

Unless differently defined, all terms used in the present specification can be construed as having the same meanings as terms generally understood by those skilled in the art to which the present disclosure pertains. Further, terms defined in generally used dictionaries are not to be interpreted as having ideal or excessively formal meanings unless they are definitely defined in the present specification.

Hereinafter, embodiments of the present disclosure will now be described in detail with reference to the accompanying drawings, identical reference numerals are assigned to indicate identical or similar elements in descriptions made with reference to the drawings, and overlapping descriptions will be omitted.

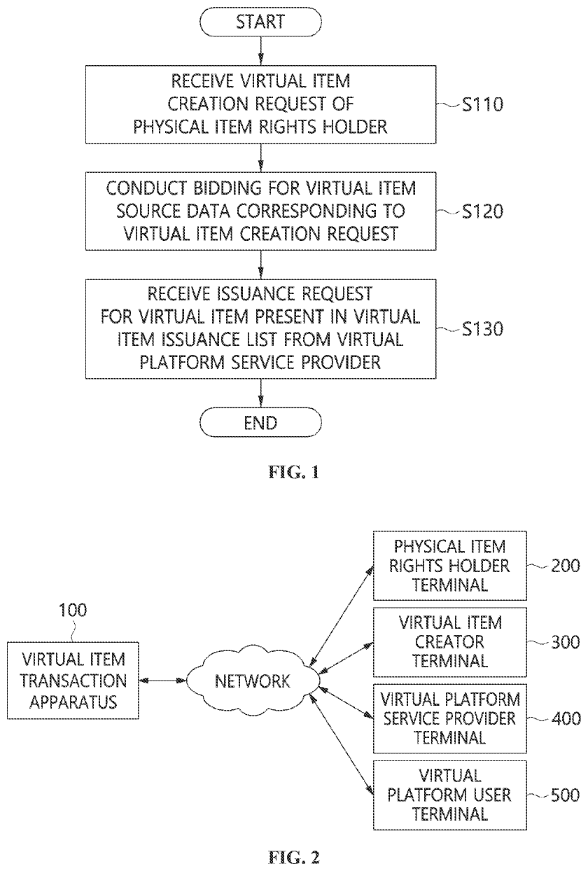

FIG. 1 is a flowchart illustrating a virtual item transaction (trading) method based on the participation of transaction entities according to an embodiment of the present disclosure.

The virtual item transaction method based on the participation of transaction entities according to the embodiment of the present disclosure may be performed by a virtual item transaction apparatus such as a computing device or a server. Further, the virtual item transaction method based on the participation of transaction entities according to the embodiment of the present disclosure may be performed by a virtual item transaction system including multiple devices and a server.

Referring to FIG. 1, the virtual item transaction method based on the participation of transaction entities according to the embodiment of the present disclosure may include step S110 of receiving the virtual item creation request of a physical item rights holder, step S120 of conducting bidding for virtual item source data corresponding to the virtual item creation request, and step S130 of receiving an issuance request for a virtual item present in a virtual item issuance list from a virtual platform service provider.

Here, the virtual item creation request of the physical item rights holder may be a response to the virtual item creation request made by a virtual item creator or the virtual platform service provider.

That is, the virtual item creation request (preparation) step may be initiated by the request of the virtual item creator or the virtual platform service provider, or may be initiated by the requirement of the physical item rights holder even though there is no request of the virtual item creator or the virtual platform service provider.

In the case where bidding for virtual item creation is initiated in response to the request of the virtual item creator or the virtual platform service provider, the bidding for virtual item creation may be initiated only when the physical item rights holder accepts the corresponding request.

Here, the virtual item creation request may include information about a virtual item creation program, the size of virtual item source data, a virtual item creation deadline, a virtual item issuance price, and a virtual item shape.

Here, the information included in the virtual item creation request may be set by the physical item rights holder.

Here, the virtual item creation request may include information about the profit distribution rate of the physical item rights holder, the virtual item creator, and the virtual platform service provider, for profit generated from the issuance of the corresponding virtual item.

Here, the information about the profit distribution rate may be set by the physical item rights holder. Here, the profit distribution rate of the virtual item transaction apparatus (agent), among the transaction entities, may be a value preset by the system or the apparatus.

As described above, an initial value for the information about the profit distribution rate may be set by the physical item rights holder, but may be changed by the request or consensus of the physical item rights holder, the virtual item creator, and the virtual platform service provider. Further, the method according to the embodiment of the present disclosure may set a threshold value for the profit distribution rate, thus preventing the profit distribution rate from exceeding a preset value.

Here, in the method, when the issuance request for the virtual item present in the virtual item issuance list is received from the virtual platform service provider at step S130, the virtual item may be rendered depending on the platform service environment and application characteristics of the corresponding virtual platform service provider.

Here, the method may further include the step of, after the virtual item source data is received, distributing the profit of the virtual item, issued based on the virtual item source data, depending on the profit distribution rate.

Here, the step of distributing the profit may include the step of calculating the profit based on the details of the virtual item finally issued to the user of the virtual platform service provided by the virtual platform service provider and distributing the calculated profit depending on a preset distribution rate.

Here, the step of conducting bidding for the virtual item source data may include the step of receiving the virtual item source data of the virtual item creator, the step of storing the received virtual item source data in a virtual item source data bid list, the step of receiving information about virtual item source data selected by the physical item rights holder, and the step of deleting source data, other than the selected virtual item source data, from the virtual item source data bid list.

That is, at the bidding conducting step, pieces of virtual item source data may be received from multiple virtual item creators, respectively. The received virtual item source data may be stored in the virtual item source data bid list, and the physical item rights holder may be requested to select which one of the pieces of source data stored in the virtual item source data bid list is to be used for bidding. When selection information is received from the physical item rights holder, pieces of source data, other than the selected virtual item source data, may be deleted or moved to a separate database.

Here, the pieces of source data, other than the selected virtual item source data, may be separately managed in a bidding failure source database, and may then be utilized again if necessary.

Here, whether to delete the pieces of source data, other than the selected virtual item source data, or to store the pieces of source data in the separate database may be determined depending on information that is set in a procedure in which the corresponding virtual item creator transmits the source data. That is, when the virtual item creator has requested data deletion in the case of failure in bidding while submitting the virtual item source data, the source data may be deleted. When the virtual item creator has requested data storage while submitting the virtual item source data, the corresponding data may be stored in the separate database. The source data present in the bidding failure source database may be designated to allow the physical item rights holder or the virtual platform service provider to view the source data.

Here, the virtual item creator may submit the source data for bidding so that an identification key for proving that the virtual item creator has created the corresponding source data is included in the source data at the time of submission.

Here, the step of conducting bidding for the virtual item source data may include the step of storing pieces of source data, other than the selected virtual item source data in the virtual item source data bid list, in a virtual item source data bidding failure list. The method may further include the step of receiving an issuance request for virtual item source data present in the virtual item source data bidding failure list from the physical item rights holder or the virtual platform service provider.

Here, the virtual item issuance list may include virtual item source data received from the physical item rights holder, and the method may include the step of, when the virtual item source data is received from the physical item rights holder, receiving information about the profit distribution rate of the physical item rights holder and the virtual platform service provider.

That is, the virtual item issuance list may include the virtual item source data selected at the bidding step. Here, in a process of storing the virtual item source data in the virtual item issuance list, the identifier of the physical item rights holder corresponding to relevant virtual item source data may be stored together with the virtual item source data. Here, the physical item rights holder may set information, such as an issuance price, an issuance quantity, and an issuance period, for the virtual item source data present in the virtual item issuance list.

Here, the physical item rights holder may store virtual item source data for which a bidding process is not yet conducted, in the virtual item issuance list. Here, the virtual item source data for which a bidding process is not yet conducted may correspond to source data personally created by the physical item rights holder or created through a separate institution or the like. Here, the physical item rights holder may set a profit distribution rate for the corresponding source data, and, in this case, a profit distribution rate for an item creator may not be taken into consideration.

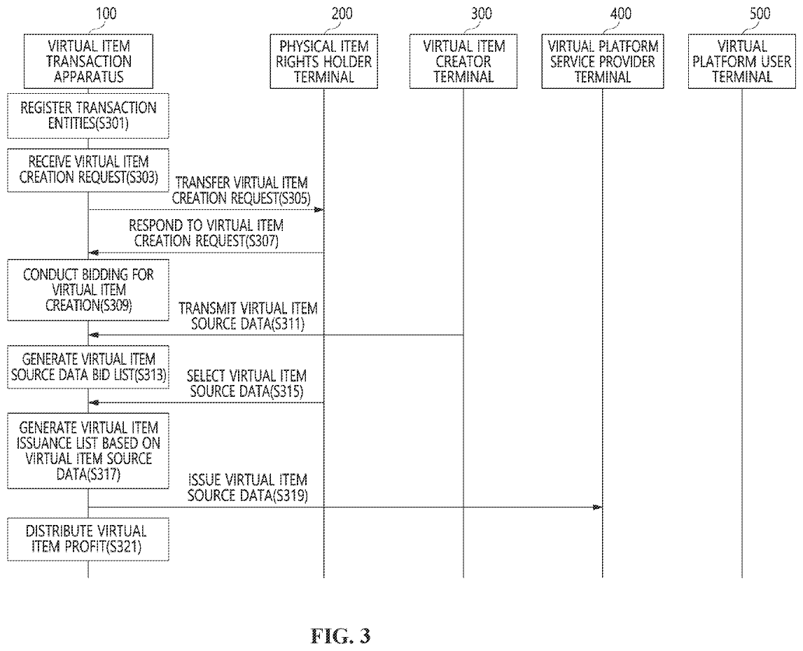

FIG. 2 is a block diagram illustrating a virtual item transaction system according to an embodiment of the present disclosure.

Referring to FIG. 2, the virtual item transaction system according to the embodiment of the present disclosure may include a virtual item transaction apparatus 100, a physical item rights holder terminal 200, a virtual item creator terminal 300, a virtual platform service provider terminal 400, a virtual platform user terminal 500, and a network.

The virtual item transaction apparatus 100 may perform functions for virtual item transactions, described above with reference to FIG. 1.

Here, each of the terminal devices 200, 300, 400, and 500 may be a device connected to a communication network to be capable of running an application, and may be any of various terminals such as all types of data communication equipment, multimedia terminals, wired terminals, fixed terminals, and Internet Protocol (IP) terminals without being limited to a computer or a mobile communication terminal. Further, each of the terminal devices 200, 300, 400, and 500 may be any of mobile terminals having various mobile communication specifications such as a mobile phone, a Portable Multimedia Player (PMP), a Mobile Internet Device (MID), a smartphone, a desktop computer, a tablet computer (Tablet PC), a notebook, Netbook, a Personal Digital Assistant (PDA), a smart TV, and data communication equipment.

The network provides a path through which data is transferred between the virtual item transaction apparatus 100 and the terminal devices 200, 300, 400, and 500, and is a concept embracing both existing networks that have been conventionally used and networks that may be developed in the future. For example, such a network may be any one of a wired/wireless Local Area Network (LAN) for providing communication between various types of information devices in a limited area, a mobile communication network for providing communication between individual moving objects and between a moving object and an external system outside the moving object, a satellite communication network for providing communication between individual earth stations using satellites, and a wired/wireless communication network, or a combination of two or more thereof. Meanwhile, transmission method standards for the network are not limited to existing transmission method standards, but may include all transmission method standards to be developed in the future.

FIG. 3 is a flowchart illustrating a virtual item transaction method for each entity according to an embodiment of the present disclosure.

The method according to the embodiment of the present disclosure may be performed by a virtual item transaction apparatus 100, a physical item rights holder 200, a virtual item creator 300, a virtual platform service provider 400, and a virtual platform user 500.

Referring to FIG. 3, the virtual item transaction apparatus (i.e., agent) 100 registers transaction entities who will participate in a transaction at step S301. Here, step S301 of registering the transaction entities may be performed in response to the requests of the physical item rights holder 200, the virtual item creator 300, the virtual platform service provider 400, and the virtual platform user 500. Here, step S301 of registering the transaction entities may correspond to the step of storing identification information or the like of the transaction entities in a data storage means such as a local server or a cloud server.

Next, the virtual item transaction apparatus (agent) 100 receives a virtual item creation request from the physical item rights holder 200, the virtual item creator 300 or the virtual platform service provider 400 at step S303. Here, the virtual item creation request may correspond to a virtual item creation request for the intellectual property of the physical item rights holder 200.

The virtual item transaction apparatus 100 which receives the virtual item creation request may transfer the corresponding virtual item creation request to the physical item rights holder 200 at step S305. Here, the virtual item transaction apparatus may transmit information about a physical item corresponding to the virtual item creation request and information about an entity requesting virtual item creation, together with the virtual item creation request.

The physical item rights holder 200 may check the virtual item creation request, and may respond to the virtual item creation request as an acceptance message or a rejection message at step S307. When the response to the virtual item creation request is rejection, bidding for virtual item creation is not performed, and the process is terminated. When the response to the virtual item creation request is acceptance, biding for virtual item creation proceeds at step S309.

Although not illustrated in FIG. 3, when bidding for virtual item creation proceeds, the virtual item transaction apparatus 100 may notify multiple virtual item creators 300 of the initiation of bidding. Here, a virtual item bidding initiation message may include information about a virtual item creation program, the size of virtual item source data, a virtual item creation deadline, a virtual item issuance price, and a virtual item shape.

When bidding for virtual item creation proceeds, the virtual item creator 300 may create source data and participate in bidding for virtual item creation at step S311. The virtual item transaction apparatus 100 may generate a virtual item source data bid list at step S313, and may store the received virtual item source data in the virtual item source bid list. The physical item rights holder 200 may select source data to bid on from among pieces of data stored in the virtual item source data bid list at step S315.

The virtual item transaction apparatus 100 generates a virtual item issuance list based on the virtual item source data selected by the physical item rights holder 200 at step S317. Furthermore, source data in the virtual item issuance list may be issued in response to the request of the virtual platform service provider 400 or the virtual platform user 500 at step S319. The virtual item transaction apparatus 100 may distribute profit generated from the issuance of the virtual item to the virtual item transaction apparatus (agent) 100, the physical item rights holder 200, the virtual item creator 300, and the virtual platform service provider 400 at step S321.

The transaction entities in the transaction method according to the embodiment of the present disclosure may include a virtual item transaction system, the physical item rights holder (an industrial property rights holder, a copyrights holder, etc.), the virtual item creator (modeling or the like), the virtual platform service provider, and the virtual platform user. Further, the target to be traded/transacted in the transaction method according to the embodiment of the present disclosure may include the virtual item source data and a virtual item issuance output.

Hereinafter, the transaction method for each step according to an embodiment of the present disclosure will be described in detail. A method, which will be described below, may be applied to the transaction entity registration step of the transaction method according to an embodiment of the present disclosure.

In the virtual item transaction system, each transaction entity who executes a series of transaction actions (such as creation bidding, bidding deposit, issuance deposit, issuance, issuance profit distribution, etc.) for each transaction step required for trading virtual items may be defined. Each transaction entity may be registered in the virtual item transaction system to perform the corresponding transaction depending on the transaction qualification for each transaction entity.

When each transaction entity is registered, the transaction entity may register specific source data usable as an identification key enabling his or her unique ID to be verified, together with the transaction entity, and may enable the specific source data to be included in virtual item source data that is the target of transaction in a specific transaction action, or in a virtual item issuance output.

A method, which will be described below, may be applied to the bidding initiation step of the transaction method according to an embodiment of the present disclosure.

In accordance with an embodiment, each transaction entity requests creation related to one or more pieces of virtual item source data by adding a specific virtual item target to the virtual item creation bid request list of the virtual item transaction system. When the physical item rights holder accepts the request, the physical item rights holder may initiate bidding for creation of the one or more pieces of virtual item source data by adding the one or more pieces of virtual item source data to the virtual item creation bidding progress list of the virtual item transaction system.

Here, the physical item rights holder may set delivery conditions, such as a bid submission deadline for virtual item source data-related creation, a delivery output format, a file size, and the application to be used, in the virtual item transaction system.

Here, the profit distribution rate of the virtual item transaction system may be a fixed value set by the virtual item transaction system. The profit distribution rate of the remaining entities, that is, the physical item rights holder, the virtual item creator, and the virtual platform service provider may be set by the physical item rights holder.

In accordance with an embodiment of the present disclosure, the physical item rights holder may independently initiate to bid for the creation of virtual item source data by adding the virtual item source data to the virtual item creation bidding progress list of the virtual item transaction system, without receiving a request to create a specific virtual item from other transaction entities.

Here, the physical item rights holder may set delivery conditions, such as a bid submission deadline for virtual item source data-related creation, a delivery output format, a file size, and the application to be used, in the virtual item transaction system.

Here, the profit distribution rate of the virtual item transaction system may be a fixed value set by the virtual item transaction system. The profit distribution rate of the remaining entities, that is, the physical item rights holder, the virtual item creator, and the virtual platform service provider may be set by the physical item rights holder.

A method, which will be described below, may be applied to the bidding step of the transaction method according to an embodiment of the present disclosure.

When the virtual item creator accepts one or more pieces of virtual item source data added to the virtual item creation bidding progress list of the virtual item transaction system, the virtual item transaction system may add the virtual item source data to the virtual item creation bidding deposit list of the virtual item transaction system. Accordingly, after the virtual item creator creates virtual item source data based on the virtual item creation bid delivery conditions set by the physical item rights holder, the virtual item creator may store the virtual item source data in a source database (DB) for virtual item creation bidding within the virtual item service server of the virtual item transaction system, thus depositing the virtual item source data for bidding.

Here, the virtual item creator may deposit the virtual item source data so that an identification key enabling the unique ID of the virtual item creator to be verified is included in the virtual item source data at the time of depositing for bidding.

The physical item rights holder may select a specific target to be deposited for issuance (successful bid) from among pieces of virtual item source data deposited for bidding. Alternatively, when a specific target is not selected from among the pieces of deposited virtual item source data (failure/losing in bidding), the progress of creation bidding may be terminated through the following process.

When the physical item rights holder selects the specific source data to make a successful bid, the virtual item source data, deposited for bidding in the virtual item creation bid source DB of the virtual item transaction system, may be deposited for issuance in the virtual item issuance source DB of the virtual item transaction system, and the remaining virtual item source data may be deleted.

When the physical item rights holder does not select source data to fail/lose in bidding, all pieces of virtual item source data, deposited for bidding in the virtual item creation bid source DB of the virtual item transaction system, may be deleted.

A method, which will be described below, may be applied to the issuance source data storage step of the transaction method according to an embodiment of the present disclosure.

In accordance with an embodiment of the present disclosure, the physical item rights holder may deposit, for issuance, the virtual item source data, which is successfully bid among the pieces of virtual item source data deposited for bidding in the virtual item creation bid source DB, in the virtual item issuance source DB provided in the virtual item service server of the virtual item transaction system.

Here, the physical item rights holder may deposit the virtual item source data so that an identification key enabling the unique ID of the physical item rights holder to be verified is included in the virtual item source data.

Here, the physical item rights holder may set an issuance price related to the virtual item source data, total issuance quantity, an issuance period, etc. in the virtual item transaction system.

Here, the profit distribution rate of the virtual item transaction system may be a fixed value set by the virtual item transaction system. Here, the profit distribution rate of the remaining transaction entities, that is, the physical item rights holder, the virtual item creator, and the virtual platform service provider, other than the virtual item transaction system, may be set in a virtual item creation bidding process.

Furthermore, in accordance with an embodiment of the present disclosure, the physical item rights holder may store virtual item source data created through a separate process in the virtual item issuance source DB to deposit the virtual item source data for issuance, without undergoing a virtual item creation bidding process.

Here, the physical item rights holder may deposit the virtual item source data so that an identification key enabling the unique ID of the physical item rights holder to be verified is included in the virtual item source data. Here, the physical item rights holder may set an issuance price related to the virtual item source data, total issuance quantity, an issuance period, etc. in the virtual item transaction system.

Here, the profit distribution rate of the virtual item transaction system may be a fixed value set by the virtual item transaction system. The profit distribution rate of the remaining transaction entities, that is, physical item rights holder and the virtual platform service provider, other than the virtual item transaction system, may be set by the physical item rights holder.

A method, which will be described below, may be applied to the virtual item issuance step of the transaction method according to an embodiment of the present disclosure.

The virtual item source data deposited for issuance at the issuance source data storage step may be added to a virtual item issuance waiting list, thus preparing for the issuance of a virtual item issuance output.

When the virtual platform user requests the virtual platform service provider to issue the virtual item issuance output added to the virtual item issuance waiting list, and the virtual platform service provider accepts the request, the virtual platform service provider may request the virtual item transaction system to issue the virtual item issuance output. When the virtual item is issued, the virtual item transaction system may issue the virtual item issuance output through the virtual platform service by adding the virtual item issuance output to the virtual item issuance request list of the virtual item transaction system.

In the issuance of the virtual item, conditions (e.g., an issuance price, total issuance quantity, an issuance period, etc.) preset at the deposit step for issuance may be applied to each transaction entity through the process.

Here, at the virtual item issuance step, the virtual item may be rendered depending on the platform service environment and application characteristics of the virtual platform service provider.

A method, which will be described below, may be applied to the profit distribution step of the transaction method according to an embodiment of the present disclosure.

For the virtual item issuance output, issuance profit may be calculated depending on the details finally issued to the virtual platform user on the virtual platform service, and may be distributed depending on the preset conditions. Here, the conditions (profit distribution rate or the like) set at the creation bidding deposit step and at the issuance deposit step may be applied to each transaction entity.

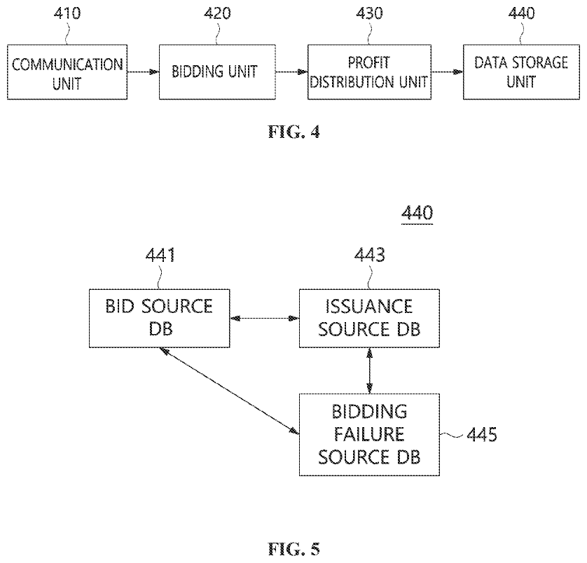

FIG. 4 is a block diagram illustrating a virtual item transaction apparatus based on the participation of transaction entities according to an embodiment of the present disclosure.

Referring to FIG. 4, the virtual item transaction apparatus based on the participation of transaction entities according to the embodiment of the present disclosure may include a communication unit 410 configured to receive the virtual item creation request of a physical item rights holder and receive an issuance request for a virtual item present in a virtual item issuance list from a virtual platform service provider, and a bidding unit 420 configured to conduct bidding for virtual item source data corresponding to the virtual item creation request.

Here, the virtual item creation request of the physical item rights holder may be a response to the virtual item creation request made by a virtual item creator or the virtual platform service provider.

Here, the virtual item creation request may include information about a virtual item creation program, the size of virtual item source data, a virtual item creation deadline, a virtual item issuance price, and a virtual item shape.

Here, the virtual item creation request may include information about the profit distribution rate of the physical item rights holder, the virtual item creator, and the virtual platform service provider, for profit generated from the issuance of the corresponding virtual item.

Here, the apparatus may further include a profit distribution unit 430 configured to distribute profit generated from the virtual item, issued based on the virtual item source data after the virtual item source data is received, depending on the profit distribution rate.

Here, the bidding unit may store virtual item source data received from the virtual item creator in a virtual item source data bid list, and may delete source data other than virtual item source data selected by the physical item rights holder.

Here, the bidding unit 420 may store source data, other than the selected virtual item source data in the virtual item source data bid list, in a virtual item source data biding failure list, and the communication unit 410 may receive an issuance request for the virtual item source data present in the virtual item source data bidding failure list from the physical item rights holder or the virtual platform service provider.

Here, the virtual item issuance list may include the virtual item source data received from the physical item rights holder, and the communication unit 410 may receive information about the profit distribution rate of the physical item rights holder and the virtual platform service provider at the time of receiving the virtual item source data from the physical item rights holder.

Here, the apparatus may include a data storage unit 440, which may perform a function of storing the virtual item source data, the virtual item source data bid list, etc.

Although not illustrated in FIG. 4, the apparatus may further include a rendering unit configured to, when the issuance request for the virtual item present in the virtual item issuance list is received from the virtual platform service provider, render the virtual item depending on the platform service environment and application characteristics of the corresponding virtual platform service provider. Here, such a rendering process may be performed by other entities in the virtual item transaction system according to an embodiment of the present disclosure, and the scope of the present disclosure is not limited thereto.

FIG. 5 is a block diagram illustrating in detail a data storage unit according to an embodiment.

Referring to FIG. 5, the data storage unit 440 may include a bid source database (DB) 441, an issuance source DB 443, and a bidding failure source DB 445. Virtual item source data received from a virtual item creator may be primarily stored in the bid source DB 441, and may be moved to the issuance source DB 443 when a successful bid is made for the virtual item source data. When bidding for the virtual item source data has failed, the corresponding source data may be deleted or moved to the bidding failure source DB 445.

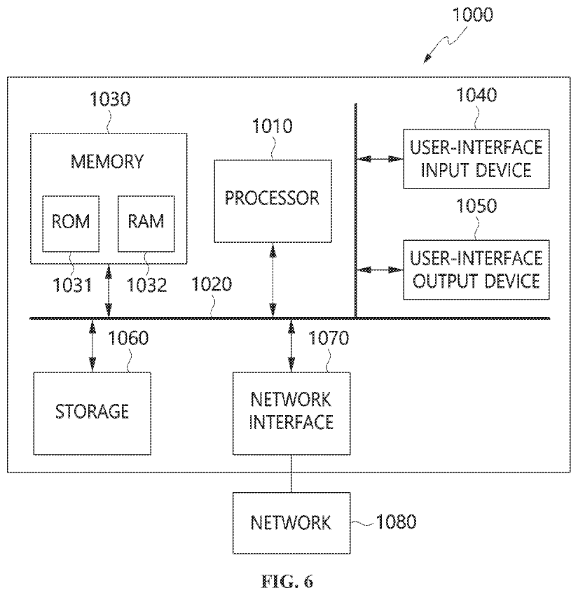

FIG. 6 is a diagram illustrating the configuration of a computer system according to an embodiment.

A virtual item transaction apparatus according to an embodiment may be implemented in a computer system 1000 such as a computer-readable storage medium.

The computer system 1000 may include one or more processors 1010, memory 1030, a user interface input device 1040, a user interface output device 1050, and storage 1060, which communicate with each other through a bus 1020. The computer system 1000 may further include a network interface 1070 connected to a network 1080. Each processor 1010 may be a Central Processing Unit (CPU) or a semiconductor device for executing programs or processing instructions stored in the memory 1030 or the storage 1060. Each of the memory 1030 and the storage 1060 may be a storage medium including at least one of a volatile medium, a nonvolatile medium, a removable medium, a non-removable medium, a communication medium or an information delivery medium, or a combination thereof. For example, the memory 1030 may include Read-Only Memory (ROM) 1031 or Random Access Memory (RAM) 1032.

The particular implementations shown and described herein are illustrative examples of the present disclosure and are not intended to limit the scope of the present disclosure in any way. For the sake of brevity, conventional electronics, control systems, software development, and other functional aspects of the systems may not be described in detail. Furthermore, the connecting lines or connectors shown in the various presented figures are intended to represent exemplary functional relationships and/or physical or logical couplings between the various elements. It should be noted that many alternative or additional functional relationships, physical connections, or logical connections may be present in an actual device. Moreover, no item or component may be essential to the practice of the present disclosure unless the element is specifically described as “essential” or “critical”.

According to the present disclosure, there can be provided a transaction environment in which a physical item rights holder, a virtual item creator, and a virtual platform service provider are capable of participating in the issuance of a virtual item.

Further, the present disclosure may efficiently distribute profit generated from the issuance of a virtual item.

Furthermore, the present disclosure may efficiently manage virtual item source data, an issuance list, etc. using databases.

Therefore, the spirit of the present disclosure should not be limitedly defined by the above-described embodiments, and it is appreciated that all scopes of the accompanying claims and equivalents thereof belong to the scope of the spirit of the present disclosure.

What is claimed is:

1. A virtual item transaction method based on participation of transaction entities, the virtual item transaction method being performed by a virtual item transaction agent to allow a physical item rights holder, a virtual item creator, and a virtual platform service provider to participate in a virtual item transaction, the virtual item transaction method comprising:
receiving a virtual item creation request of the physical item rights holder;
conducting bidding for virtual item source data corresponding to the virtual item creation request; and
receiving an issuance request for a virtual item present in a virtual item issuance list from the virtual platform service provider.

2. The virtual item transaction method of claim 1, wherein the virtual item creation request of the physical item rights holder corresponds to a response to a virtual item creation request of the virtual item creator or the virtual platform service provider.

3. The virtual item transaction method of claim 1, wherein the virtual item creation request includes information about a virtual item creation program, a size of virtual item source data, a virtual item creation deadline, a virtual item issuance price, and a virtual item shape.

4. The virtual item transaction method of claim 1, wherein the virtual item creation request includes information about a profit distribution rate of the physical item rights holder, the virtual item creator, and the virtual platform service provider, for profit generated from issuance of a corresponding virtual item.

5. The virtual item transaction method of claim 4, further comprising:
after the virtual item source data is received, distributing profit, generated from a virtual item issued based on the virtual item source data, depending on the profit distribution rate.

6. The virtual item transaction method of claim 1, wherein conducting bidding for the virtual item source data comprises:
receiving virtual item source data from the virtual item creator;
storing the received virtual item source data in a virtual item source data bid list;
receiving information about virtual item source data selected by the physical item rights holder; and
deleting source data, other than the selected virtual item source data, from the virtual item source data bid list.

7. The virtual item transaction method of claim 6, wherein:
conducting bidding for the virtual item source data further comprises:
storing source data, other than the selected virtual item source data in the virtual item source data bid list, in a virtual item source data bidding failure list, and
the virtual item transaction method further comprises:
receiving an issuance request for virtual item source data present in the virtual item source data biding failure list from the physical item rights holder or the virtual platform service provider.

8. The virtual item transaction method of claim 1, wherein:
the virtual item issuance list includes virtual item source data received from the physical item rights holder, and
the virtual item transaction method further comprises:
when the virtual item source data is received from the physical item rights holder, receiving information about a profit distribution rate of the physical item rights holder and the virtual platform service provider.

9. A virtual item transaction apparatus based on participation of transaction entities for performing a virtual item transaction in which a physical item rights holder, a virtual item creator, and a virtual platform service provider participate, the virtual item transaction apparatus comprising:
a communication unit configured to receive a virtual item creation request of a physical item rights holder and receive an issuance request for a virtual item present in a virtual item issuance list from the virtual platform service provider; and
a bidding unit configured to conduct bidding for virtual item source data corresponding to the virtual item creation request.

10. The virtual item transaction apparatus of claim 9, wherein the virtual item creation request of the physical item rights holder corresponds to a response to a virtual item creation request of the virtual item creator or the virtual platform service provider.

11. The virtual item transaction apparatus of claim 9, wherein the virtual item creation request includes information about a virtual item creation program, a size of virtual item source data, a virtual item creation deadline, a virtual item issuance price, and a virtual item shape.

12. The virtual item transaction apparatus of claim 9, wherein the virtual item creation request includes information about a profit distribution rate of the physical item rights holder, the virtual item creator, and the virtual platform service provider, for profit generated from issuance of a corresponding virtual item.

13. The virtual item transaction apparatus of claim 12, further comprising:
a profit distribution unit configured to distribute profit, generated from a virtual item issued based on the virtual item source data after the virtual item source data is received, depending on the profit distribution rate.

14. The virtual item transaction apparatus of claim 9, wherein the bidding unit is configured to store virtual item source data received from the virtual item creator in a virtual item source data bid list and delete source data, other than virtual item source data selected by the physical item rights holder.

15. The virtual item transaction apparatus of claim 14, wherein:
the bidding unit is configured to store source data, other than the selected virtual item source data in the virtual item source data bid list, in a virtual item source data bidding failure list, and
the communication unit is configured to receive an issuance request for virtual item source data present in the virtual item source data biding failure list from the physical item rights holder or the virtual platform service provider.
